(19) United States
(12) Patent Application Publication
(10) Pub. No.: US 2009/0009575 A1
(43) Pub. Date: Jan. 8, 2009

(54) FILTER, LIQUID EJECTING HEAD, LIQUID EJECTING APPARATUS, AND PRESS WORKING METHOD

(75) Inventors: Shinichi TONAMI, Sakata-shi (JP); Satoshi MATSUURA, Sakata-shi (JP); Narimitsu SAITO, Sakata-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/166,738

(22) Filed: Jul. 2, 2008

(30) Foreign Application Priority Data
Jul. 5, 2007 (JP) 2007-177169

(51) Int. Cl. B41J 2/175; B01D 35/00

(52) U.S. Cl. 347/93; 210/106

(57) ABSTRACT

There is provided a filter having a plate-like shape in which a plurality of holes through which fluid passes is opened. A low opening region in which an aperture ratio of the holes per unit area is low and a high opening region in which an aperture ratio of the holes per unit area is high are formed in the filter.

### CROSS-REFERENCE TO RELATED APPLICATIONS

This application claims the benefit of priority to Japanese Patent Application No. 2007-177169 filed Jul. 5, 2007, the contents of which are hereby incorporated by reference in their entirety.

### BACKGROUND

1. Technical Field

The present invention relates to a plate like filter in which a plurality of holes through which fluid passes, a liquid ejecting head and a liquid ejecting apparatus equipped with the filter, and a press working method for working the filter.

2. Related Art

As a liquid ejecting apparatus for ejecting liquid as a liquid drop from a nozzle opening by generating pressure fluctuation to liquid in a pressure chamber, it has been known an image recording apparatus such as an ink jet type recording apparatus (hereinafter, simply referred to as a printer). In such a printer, by inserting an ink introducing needle whose distal end has a sharp angle into an ink cartridge (hereinafter, simply referred to as cartridge) in which ink in the form of liquid is enclosed, the ink in the cartridge is introduced into a pressure chamber of a recording head through an introducing hole opened at a distal end of the ink introducing needle.

In the recording head having the aforementioned structure, it is ideal that an ink flow path provided from the ink introducing needle to a nozzle opening of the recording head is filled with ink. However, it may be occur that bubbles are entered into the ink flow path when filling ink in the recording head (initial filling) or when the ink cartridge is changed, or the like, and it is impossible to perfectively prevent the entrance of bubbles. The bubbles entered into the ink flow path gradually grow up, and if a part of the bubbles excessively grown up is moved at the pressure chamber side by the flow of ink, there is fear that disadvantages such as pressure loss caused when the bubbles absorb pressure fluctuation at ejecting operation, shortage of ink supply caused when the bubbles close the flow path, and the like are invited.

A wide variety of recording heads have been developed in order to prevent such the disadvantages caused by bubbles. As an example, a recording head has been proposed in which an elastic body is equipped at a side wall of a filter chamber by which the width of the ink flow path is increased and in which a filter is disposed. In the recording head, when a negative pressure is applied in the filter chamber when cleaning operation for forcibly discharging ink and bubbles from the nozzle openings is performed, the elastic body is deformed inside to narrow the flow path, thereby making it easy to discharge the bubbles (for example, see JP-A-2000-296622).

However, it is difficult to absolutely discharge bubbles also in the aforementioned recording head. Further, the size of the filter is set larger than the cross section of the flow path in order to reduce pressure loss when fluid passes through the filter. However there is a speed difference in the fluid flowing down in the flow path due to viscosity resistance to the wall of the flow path, and flow speed is fast at the center of the flow path. Accordingly, bubbles in the fluid are captured at the center of the filter in a concentrated manner. When the captured bubbles are developed, not only pressure loss is increased, but also there is a fear that the bubbles close the flow path. In order to prevent the disadvantages, it becomes necessary to perform a cleaning operation with frequency. Further, the aperture ratio of the entire filter may be enhanced in order to reduce the pressure loss caused by the filter. However, a necessary strength can not be obtained by simply increasing the area of the holes, and there occurs a fear of damage, and ability of filtration becomes insufficient.

### SUMMARY

An advantage of some aspects of the invention is to provided a filter capable of reducing pressure loss of fluid while keeping the strength of the filter, a liquid ejecting head and a liquid ejecting apparatus equipped with the same, and a press working method for working the filter.

According to an aspect of the invention, there is provided a filter having a plate-like shape in which a plurality of holes through which fluid passes is opened. A low opening region in which an aperture ratio of the holes per unit area is low and a high opening region in which an aperture ratio of the holes per unit area is high are formed in the filter.

According to the aforementioned structure, the low opening region in which an aperture ratio of the holes per unit area is low and the high opening region in which an aperture ratio of the holes per unit area is high are formed in the filter. Accordingly, the strength of the whole filter can be assured and pressure loss of fluid can be lessened without impairing the filtration function of the filter for trapping a foreign substance by disposing the low opening region and the high opening region in accordance with the pressure of fluid with respect to the filter. Further, discharge property of bubbles can be improved by introducing bubbles in fluid that are inevitably remained at the upstream side of the filter with the flowing down of fluid to the high opening region.

It is preferable that a diameter of the hole in the high opening region is larger than a diameter of the hole in the low opening region in the above structure.

According to the above structure, it is not necessary to increase the number of holes to be opened for forming the high opening region. Accordingly, fabrication of the filter can be easily performed.

It is preferable that the number of the holes in the high opening region is larger than the number of holes in the low opening region in the above structure.

According to the above structure, the regions having a different aperture ratio can be formed by using a same type of punch.

It is preferable that an aperture ratio of the holes is set to become higher as the holes approaches toward a center from an outer edge of the filter.

According to the above structure, pressure loss at the center of the filter can be reduced as much as possible. Accordingly, bubbles in fluid can be efficiently discharged.

It is preferable that the filter is bent toward a center from an outer edge so as to project toward a falling direction of fluid in the above structure.

According to the above structure, the center of the filter is positioned at the most downstream side, so that fluid at the upstream side before passing the filter falls down along the surface of the filter at the upstream side and is to be inevitably assembled at a part (center) of the filter. Consequently, the bubbles assembled at one portion can be efficiently discharged.

Further, according to another aspect of the invention, there is provided a liquid ejecting head for introducing fluid into a pressure chamber via a liquid flow path and for ejecting a liquid drop from a nozzle opening by pressure fluctuation. The filter according to the aspect of the invention is equipped at a mid stream of the liquid flow path.

Further, according to still another aspect of the invention, there is provided a liquid ejecting apparatus including the liquid ejecting head according to the another aspect of the invention.

According to the above structure, a fear that the flow path of the liquid ejecting head is closed is reduced, so that the reliability of the liquid ejecting head and the liquid ejecting apparatus is improved.

Further, according to a still another aspect of the invention, there is provided a press working method for working a filter by forming through holes by using punch groups in which plurality of punches are arranged with respect to a processed material. The punch groups includes, a first punch group in which a standard cutting blade having a standard diameter is provided at a distal end of the punch, a second punch group in which a standard cutting blade having the standard diameter is provided at a distal end of the punch and in which a large diameter cutting blade whose diameter is larger than the standard diameter is provided at a proximal side of the standard cutting blade. A filter in which a low opening region in which an aperture ratio of the holes per unit area is low and a high opening region in which an aperture ratio of the holes per unit area is high are formed is fabricated by changing a punching distance when the punch groups are punched into the processed material.

According to the above structure, the through holes having a standard diameter can be opened at the same time and the through holes having a standard diameter and the through holes whose diameter is larger than the standard diameter can be opened by using the same punch groups by aligning the first punch group and the second punch group on a same plane and by changing a punching distance when punching into the processed material. Consequently a labor hour for exchanging the punch groups can be eliminated, and the low opening region and the high opening region can be easily formed in the processed material to fabricate the filter.

### BRIEF DESCRIPTION OF THE DRAWINGS

The invention will be described with reference to the accompanying drawings, wherein like numbers reference like elements.

FIG. 1 is a perspective view showing a structure of a printer.

FIG. 2 is an exploded perspective view showing a structure of a recording head.

FIG. 3 is a plan view showing a structure of the recording head.

FIG. 4 is a cross sectional view showing an inner structure of the recording head.

FIG. 5 is a partial cross sectional view showing an inner structure of the recording head.

FIG. 6 is a cross sectional view showing an ink introducing needle in the needle longitudinal direction.

FIG. 7 is a plan view of a filter.

FIG. 8A is an enlarged view showing a low opening area of the filter, and FIG. 8B is an enlarged view showing a high opening area of the filter.

FIG. 9 is a main portion cross sectional view showing a process for forming through holes in a processed material.

FIG. 10A is an enlarged view showing a low opening area in a modification example of the filter, and FIG. 10B is an enlarged view showing a high opening region in the modification example of the filter.

FIG. 11 is a cross sectional view showing a modification example of the filter.

### DESCRIPTION OF EXEMPLARY EMBODIMENTS

Hereinafter, a best mode for carrying out the invention will be described with reference to the accompanying drawings. Various limitations are imposed on the embodiment described below as a preferable concrete example of the invention. However, the scope of the invention is not limited to the illustrative embodiment unless there is a clear statement for restricting the invention. Further, in the embodiment, an ink jet type recording head (hereinafter, referred to as a “recording head”) is exemplified as an example of a liquid ejecting head.

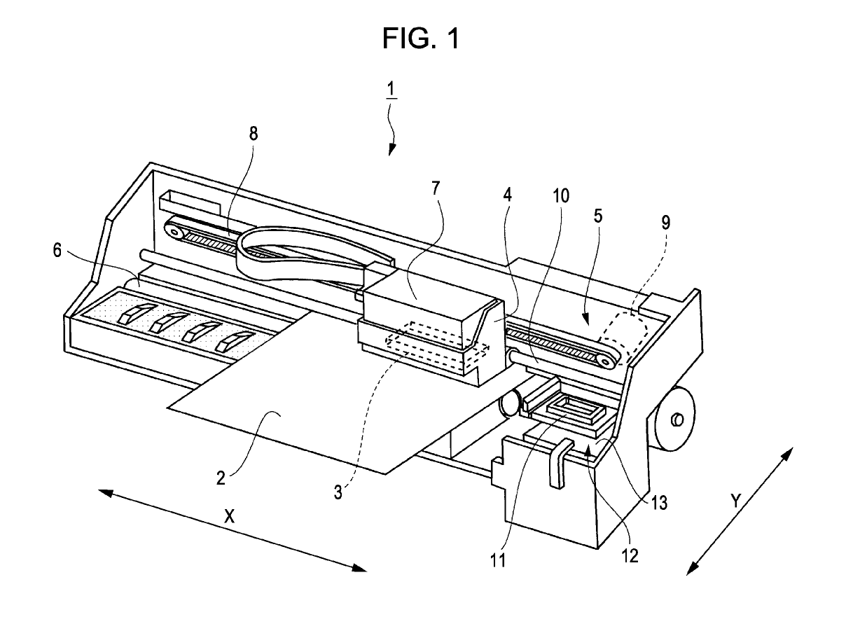

FIG. 1 is a perspective view showing an ink jet type recording apparatus. First, a structure of an outline of the ink jet type recording apparatus (hereinafter, referred to as a printer) mounting a recording head will be described with reference to FIG. 1. The exemplified printer 1 is an apparatus for recording an image or the like by ejecting ink in the form of liquid on a surface of a recording medium 2 (object to be ejected) such as a recording paper. The printer 1 is equipped with a recording head 3 for ejecting ink (corresponding to a sort of the liquid ejecting head in the invention), a carriage 4 to which the recording head 3 is attached, a carriage moving mechanism 5 for moving the carriage 4 in a main scanning direction (direction shown by symbol X in FIG. 1), a platen roller 6 for transporting the recording medium 2 in a sub scanning direction (direction perpendicular to the main scanning direction, direction shown by symbol Y in FIG. 1), and the like. Herein, the aforementioned ink is a sort of the liquid of the invention and is stored in an ink cartridge 7. The ink cartridge 7 is attached to the recording head 3 in a detachable manner.

The carriage moving mechanism 5 is equipped with a timing belt 8 driven by a pulse motor 9 such as a DC motor. Accordingly, when the pulse motor 9 is operated, the carriage 4 is guided by a guide rod 10 provided to the printer 1 and reciprocally moved in the main scanning direction X (width direction of the recording paper 2).

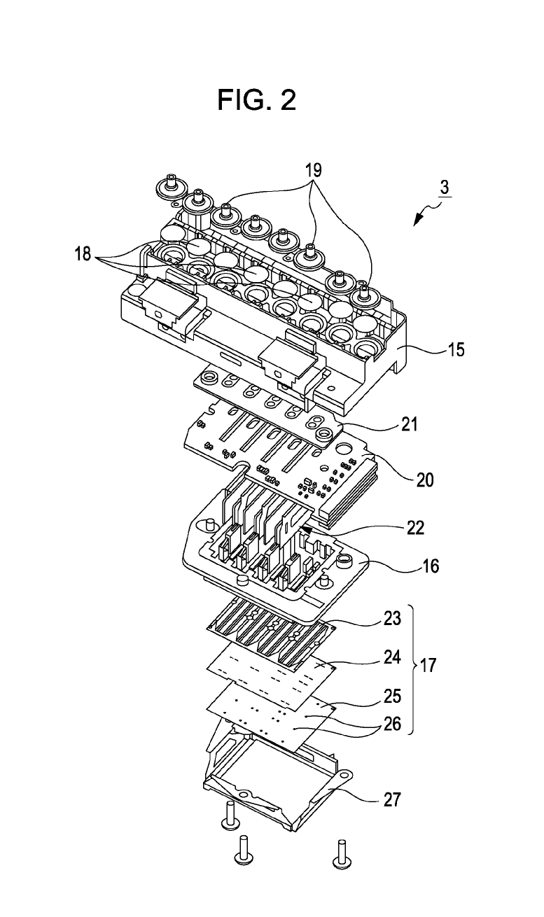

A capping mechanism 12 is provided at a home position which is a non recording area of the printer 1. The capping mechanism 12 has a tray shaped cap member 11 which may be made contact with a nozzle forming surface (nozzle plate 25) of the recording head 3 to be described below. In the capping mechanism 12, the space in the cap member 11 functions as a sealed space, and the capping mechanism 12 is constituted so as to be able to be attached firmly to the nozzle forming surface in the state where nozzle openings 26 of the recording head 3 (see FIG. 2) is placed in the sealed space. Further, a pump unit 13 is connected to the capping mechanism 12. By operating the pump unit 13, a negative pressure can be applied in the sealed space. When the pump unit 13 is operated in the state where the nozzle forming surface is closely attached to the cap member 11 and negative pressure is applied to the sealed space (enclosed space), ink and bubbles in the recording head 3 are to be suctioned from the nozzle openings 26 to be discharged into the sealed space of the cap member 11. That is, the capping mechanism 12 performs operation for forcibly suctioning and discharging the ink and bubbles in the recording head 3 (hereinafter, refereed to as cleaning operation). The detail of the cleaning operation will be described below.

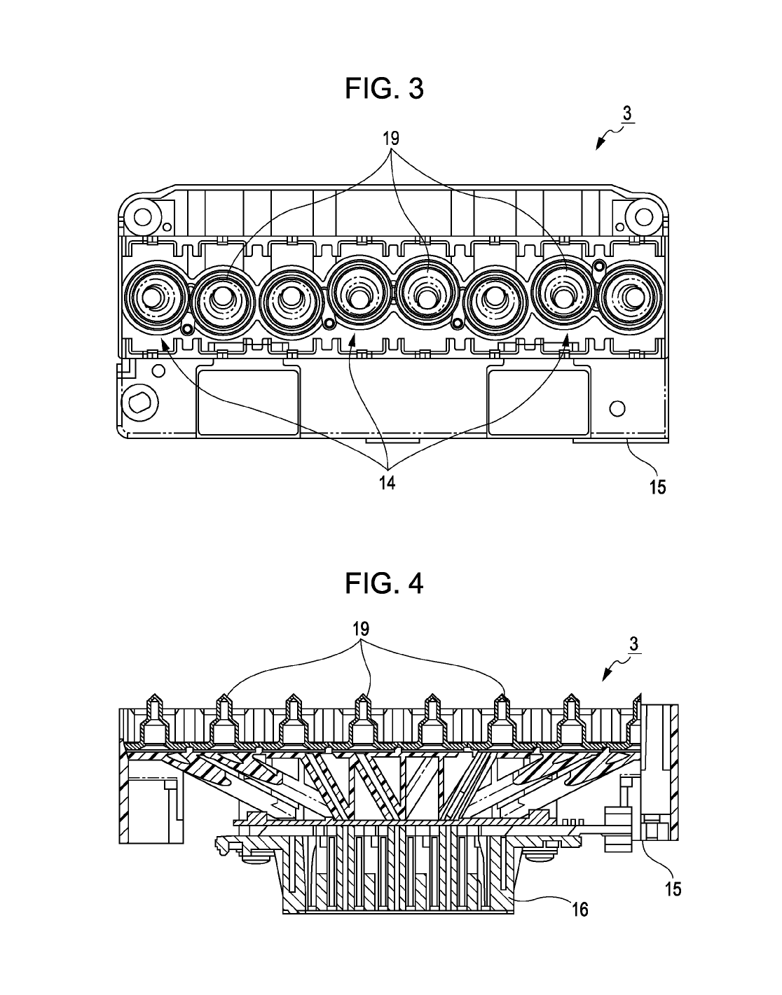

Next, a structure of the recording head 3 will be described. Herein, FIG. 2 is an exploded perspective view showing the recording head 3 attached to the carriage, FIG. 3 is a plan view of the recording head 3, and FIG. 4 is a cross sectional view of the recording head 3.

The exemplified recording head 3 is roughly constituted by a cartridge base 15 (hereinafter, referred to as “base”) a head case 16, a flow path unit 17, a vibrator unit 22, and the like.

The base 15 is formed and shaped by, for example, a synthetic resin, and a plurality of partitions 14 (liquid storage member applied part) are provided on the upper surface of the base 15 as shown in FIG. 3. An ink introducing needle 19 is attached to each partition 14 in the state where a filter 18 is intervened. Then, the ink cartridge 7 is to be attached on the partitions 14. That is, the ink cartridge 7 is attached in the state where positioned on the base 15. Note that the detail of the ink cartridge 7, the filter 18 and the ink introducing needle 19 will be described below.

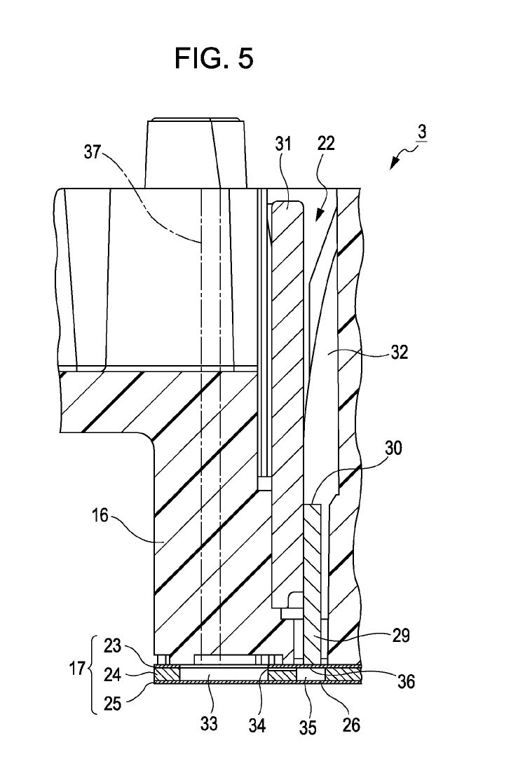

As shown in FIG. 2, a circuit substrate 20 is attached on the other surface of the base 15 opposite to the aforementioned partition 14 side. The circuit substrate 20 is equipped with a drive circuit for, for example, controlling supply of a driving signal to a piezoelectric vibrator 29 (see FIG. 5) described below, a connector for connecting to the side of a printer main body, through holes for supplying ink, and the like. Then the circuit substrate 20 is attached to the base 15 via a sheet member 21 that functions as a packing.

The head case 16 is the one that is fixed to the base 15, and the head case 16 is a casing for accommodating the vibrator unit 22 having the piezoelectric vibrator 29 described below. Accordingly, an accommodating hollow portion 32 (see FIG. 5) capable of accommodating the vibrator unit 22 is formed in the head case 16. Then the vibrator unit 22 is inserted into the accommodating hollow portion 32 and fixed by adhesion or the like. Then, a flow path unit 17 is fixed at a distal surface of the head case 16 opposite to the side of the attachment surface of the base 15 by an adhesive agent or the like.

The follow path unit 17 is manufactured by bonding and uniting an elastic plate 23, a flow path forming substrate 24, and a nozzle plate 25 by an adhesive agent or the like under a laminated state.

The nozzle plate 25 is a member manufactured by a thin plate made of, for example, stainless. Fine nozzle openings 26 are formed in a line manner at a pitch corresponding to a dot formation density of the printer 1.

A head cover 27 is attached at a distal end of the head case 16 so as to surround the peripheral border of the nozzle plate 25 from the outside. The head cover 27 is manufactured by, for example, a thin plate member made of a metal. The head cover 27 protects the flow path unit 17 and the distal end of the head case 16 and has a function to prevent the nozzle plate 25 to be charged.

FIG. 5 is a main portion cross sectional view of the recording head 3. The aforementioned vibrator unit 22 is constituted by a piezoelectric vibrator group 30 as pressure generating means, a fix plate 31 to which the piezoelectric vibrator group 30 is jointed, a flexible cable (not shown) for supplying a driving signal to the piezoelectric vibrator group 30 from the circuit substrate 20, and the like. The piezoelectric vibrator group 30 of the embodiment is equipped with a plurality of piezoelectric vibrators 29 aligned and provided in a comb like manner. In each of the piezoelectric vibrators 29, a fixed end is jointed on the fix plate 31 and a free end is projected outside of the distal surface of the fix plate 31. That is, each of the piezoelectric vibrators 29 is attached on the fix plate 31 in so-called a cantilever state. Further, the fix plate 31 that supports each piezoelectric vibrator 29 is constituted by, for example, stainless steel having a thickness of about 1 mm. Note that besides the aforementioned piezoelectric vibrator, an electrostatic actuator, a magnetostrictive element, a heater element, or the like can be used as for the pressure generating means.

An accommodating hollow portion 32 (see FIG. 5) capable of accommodating the aforementioned vibrator unit 22 is formed in the head case 16 in the state where the accommodating hollow portion 32 passes through the head case 16 in the height direction. The vibration unit 22 is stored and fixed in the accommodating hollow portion 32 by bonding the back surface of the fix plate 31 to the inner wall surface of the case that blocks out the accommodating hollow portion 32.

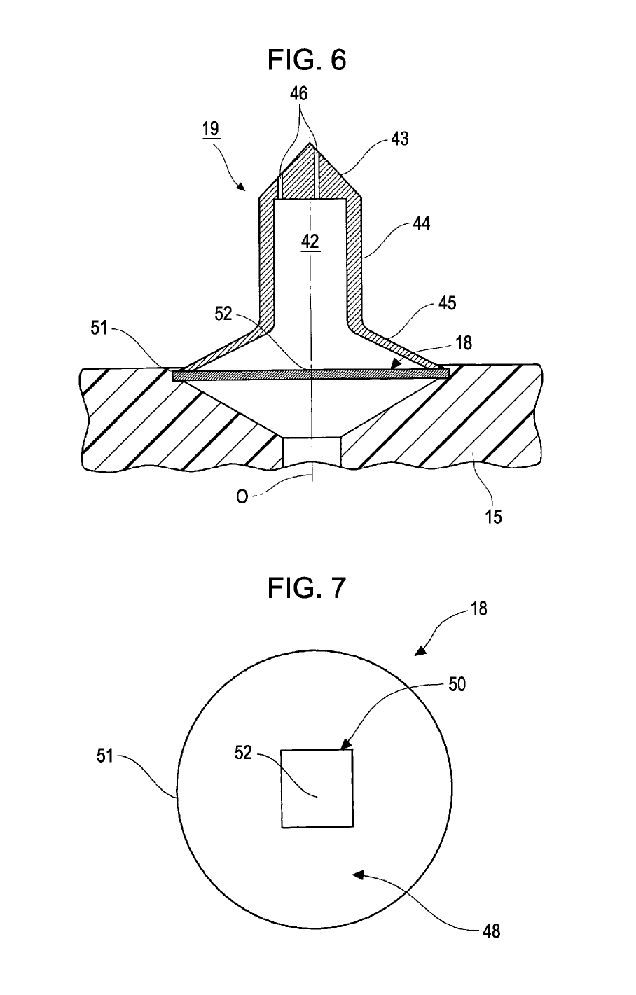

The flow path forming substrate 24 is a plate-like member in which a hollow portion which become a common ink chamber 33, a plurality of grooves which become ink supplying openings 34 and hollow portions which become pressure chambers 35 are formed so as to correspond to each nozzle opening 26 in the state where the hollow portions and the grooves are separated by partition walls. The flow path forming substrate 24 is manufactured by, for example, subjecting a silicon wafer to an etching processing. The aforementioned pressure chamber 35 is formed as a chamber elongated in the direction perpendicular to the aligned and provided direction (nozzle alignment direction) of the nozzle openings 26. Further, the common ink chamber 33 is communicated with an ink introducing path 42 (see FIG. 6) described below of the ink introducing needle 19 via an ink communication path 37 (corresponding to the liquid flow path of the invention) formed so as to pass through the head case 16 in the height direction, and is a chamber into which the ink stored in the ink cartridge 7 is introduced. Then, the ink introduced into the common ink chamber 33 is supplied to each pressure chamber 35 via the corresponding ink supplying opening 34.

The elastic plate 23 is a composite board having a double structure in which an elastic film is subjected to a laminate treatment on a supporting plate made of a metal such as a stainless steel or the like. An island portion 36 for jointing a distal end of the free end of the piezoelectric vibrator 29 is formed at the portion of the vibration plate 23 corresponding to the pressure chamber 35, and the portion functions as a diaphragm portion. In addition, the elastic plate 23 seals one of the opening surfaces of the hollow potion which becomes the common ink chamber 33 and also functions as a compliance portion. The portion functions as the compliance portion is only the elastic film.

In the recording head 3, when the piezoelectric vibrator 29 is elongated and contracted in the element longitudinal direction, the island portion 36 is moved in the direction close to or apart from the pressure chamber 35. Herewith, the capacity of the pressure chamber 35 is changed and pressure fluctuation is generated in the ink in the pressure chamber 35. By the pressure fluctuation, an ink drop (a sort of a liquid drop) is ejected from the nozzle opening 26.

Next, the aforementioned cartridge 7 will be described. The cartridge 7 is a member for storing ink to be supplied to the recording head 3. The printer 1 of the embodiment is constituted so as to be able to eject eight types of inks, concretely, inks of eight colors in total comprising yellow, magenta, cyan and the like, and eights ink cartridges 7 in total in which each ink is separately stored are attached in the recording head 3. A needle insertion opening (not shown) is provided at the bottom surface of each ink cartridge 7. The needle insertion opening is a portion into which the ink introducing needle 19 is inserted. When shipped from a factory, the needle insertion opening is enclosed by a film (not shown) to prevent invasion of air into the cartridge. This is because to keep a degassing state till right before using the cartridge since the ink in the ink cartridge 7 is stored in the degassing (negative pressure) state.

Next, a structure of the ink introducing needle 19 inserted into the ink cartridge 7 will be described. FIG. 6 is a cross sectional view of the ink introducing needle 19 in the needle longitudinal direction. The ink introducing needle 19 is a hollow needle whose inner space is an ink introducing path 42 (corresponding to a part of the liquid flow path in the invention). The ink introducing needle 19 is constituted by a conic shaped pointed end 43 formed in a tapered shape, a straight portion 44 having a cylinder shape continuously formed at the downstream side of the pointed end 43, and a diameter enlarged portion 45 which is continuously formed at the downstream side of the straight portion 44 and whose inner diameter is larger than the inner diameter of the straight portion 44. In the embodiment, ink introducing holes 46 that communicate an outside of the introducing needle (outer space) with the ink introducing path 42 are opened. Further, the diameter enlarged portion 45 is manufactured in a taper shape so that the diameter is gradually enlarged from the upstream side (side of straight portion) toward the downstream side (side of the proximal end of the needle), and a disk shaped filter 18 is disposed in the diameter enlarged portion 45 on the center axis (shown by symbol ◯ in FIG. 6) at the upstream end opening of the diameter enlarged portion 45. Accordingly, fluid (ink, bubbles, and the like) whose flow speed is fast passes through the circumference of a center 52 rather than the area near an outer edge 51.

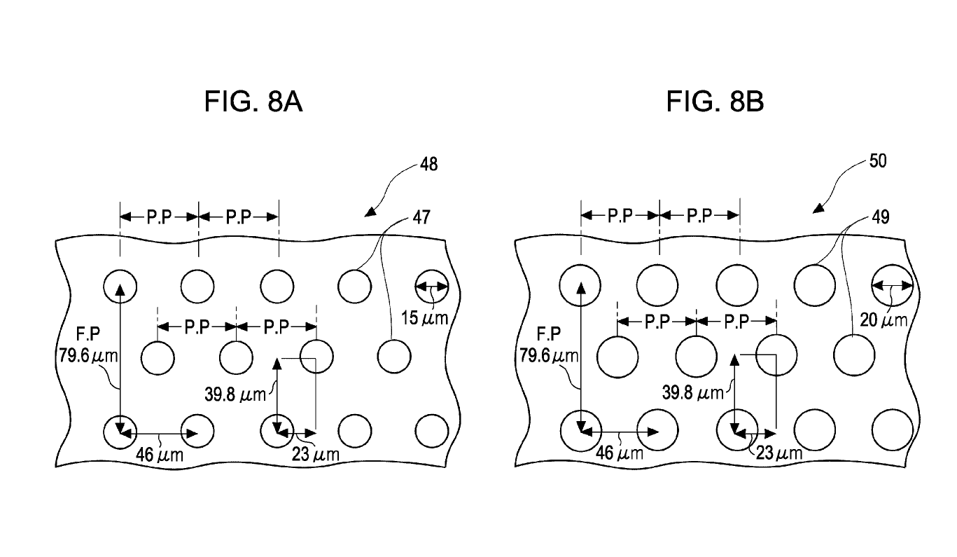

The filter 18 is constituted as a circular board made of a metal (for example, stainless plate) in which a large number of small through holes 47, 49 are opened. The through holes 47, 49 are penetrated from one of the surfaces of the filter 18 to the other surface. Fluid such as ink, bubbles, and the like penetrates the through holes 47, 49. Note that, in the embodiment, the thickness of the filter 18 is about 10 to 15 μm. Further, the diameter of the through holes 47 is 15 μm (see FIG. 8A), and the diameter of the through holes 49 is 20 μm (see FIG. 8B). That is, the diameter of the through holes 49 is larger than the diameter of the through holes 47.

Accordingly, as shown in FIGS. 7, 8, when the through holes 47 are formed, a low opening region 48 in which aperture ratio of holes per unit area is low is formed in the filter 18, and when the through holes 49 whose diameter is larger than that of the through holes 47 are formed, a high opening region 50 in which aperture ratio of holes per unit area is high is formed in the filter 18. That is, in the embodiment, the through holes 49 in the high opening region 50 is formed so that the diameter thereof is larger than the diameter of the through holes 47 in the low opening region 48.

As shown in FIG. 7, such the low opening region 48 is formed at the vicinity of the outer edge 51 of the filter 18. The high opening region 50 is formed at the center 52 of the filter in a square shape. That is, the high open are 50 is surrounded by the low opening region 48. Note that it goes without saying that the shape of the high opening region 50 is not limited to the square shape and can be appropriately modified to, for example, a hexagonal shape, an octagon shape, a circle shape, or the like. Further, the high opening region 50 of a square shape as in the embodiment is easy to be fabricated by using a punch, so that it is possible to improve the manufacturing efficiency of the filter 18.

In this manner, the low opening region 48 in which aperture ratio of holes per unit area is low and the high opening region 50 in which aperture ratio is higher than that of the low opening region 48 are formed in the filter 18 in the embodiment. Accordingly, the strength of the whole filter 18 can be assured and pressure loss of fluid (ink, bubbles, and the like) can be lessened without impairing the filtration function of the filter 18 for trapping a foreign substance by disposing the low opening region 48 and the high opening region 50 in accordance with the flow speed of fluid (ink, bubbles, and the like) with respect to the filter 18. Further, discharge property of bubbles can be improved by introducing bubbles in fluid that are inevitably remained at the upstream side of the filter 18 with the flowing down of fluid (ink, bubbles, and the like) to the high opening region 50.

The printer 1 equipped with the recording head 3 of the embodiment is equipped with the aforementioned filter 18. Accordingly, reliability is improved as the remaining of bubbles that close the flow path of the liquid ejecting head 3 is reduced.

Further, the diameter of thee through holes 49 in the high opening region 50 is larger than the diameter of the through holes 47 in the low opening region 48. Accordingly, it is not necessary to increase the number of the through holes 49 to be opened in order to form the high opening region 50. Accordingly, the filter 18 can be easily fabricated.

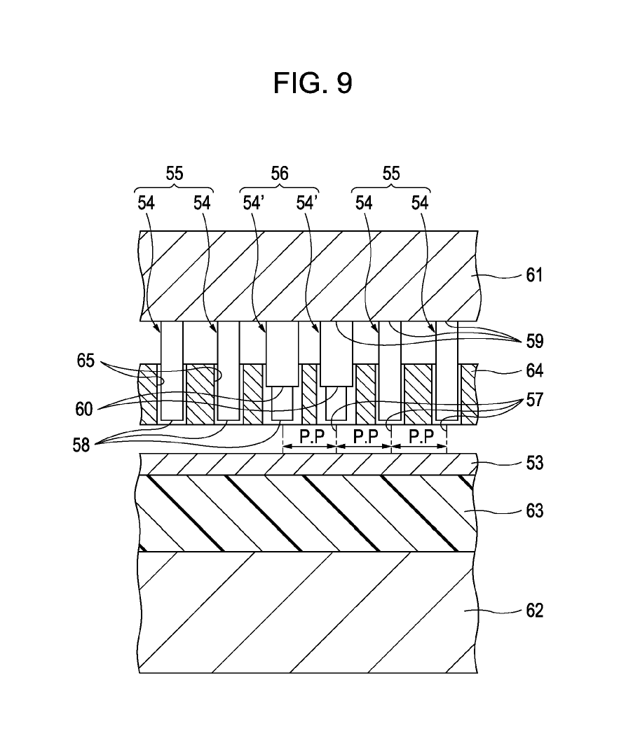

Next, a press working process for working the filter 18 by which the through holes 47, 49 are opened by using punch groups 55, 56 in which a plurality of punches 54, 54′ are arranged on a plate like processed material 53 will be described. FIG. 9 is a main portion cross sectional view showing an upper metal mold and the like for illustrating a process for forming the through holes in the processed material 53. The punch groups 55, 56 of the upper metal mold is constituted by a first punch group 55 in which a standard cutting blade 58 whose diameter is set to a standard diameter is provided at the distal end 57 of each of the punches 54, and a second punch group 56 in which a standard cutting blade 58 whose diameter is set to a standard diameter is provided the distal end 57 of each of the punches 54′ and in which a large diameter cutting blade 60 whose diameter is larger than the standard diameter is provided at the proximal end 59 side of the standard cutting blade 58. The distal end 59 of each of the punches 54, 54′ is attached to a punch holder 61. The punches 54, 54′ of the punch groups 55, 56 are arranged on a straight line at the same pitch P.P to form a comb like shape. In the embodiment, the diameter of the standard cutting blade 58 shall be 15 μm, and the diameter of the large diameter cutting blade 60 shall be 20 μm.

Then, as shown in FIG. 9, each of the distal ends 57 of the punches 54, 54′ of the punch groups 55, 56, is inserted into a corresponding guide hole 65 of a stripper plate 64 biased at the side of a pedestal 62 by a coil spring or the like. Herewith, the distal end 57 of each of the punches 54, 54′ of the punch groups 55, 56 is arranged so as to face the processed material 53. Note that the processed material 53 is placed on an elastic mat 63 made of an elastic material disposed on the upper surface of the pedestal 62. Further, the punching holder 61 is fixed to a slide (ram) of a press working machine and moves up and down with the slide.

Next, a press working method will be described. The punching holder 61 is lowered in the state where the distal end 57 of each of the punches 54, 54′ of the punch groups 55, 56 is faced to the processed material 53. Then, the lower surface of the stripper plate 64 is made contact with the front surface of the processed material 53. Then, when the punching holder 61 is further lowered in the lower direction while resisting the biasing force of the coil spring that biasing the striper plate 64 in the lower direction, the standard cutting blade 58 of the punches 54, 54′ are guided by the guide holes 65 of the stripper plate 64 and punched into the processed material 53. Herewith, the punches 54, 54′ pass through the processed material 53 and the through holes 47 whose shape is approximately the same as the outer shape of the standard cutting blade 58 (standard diameter: 15 μm) are formed. That is, each of the punches 54 and the punches 54′ forms the through hole 47 whose inner circumference has approximately the same shape as the outer shape of the standard cutting blade 58. Accordingly, the through holes 47 for the low opening region 48 are formed by the standard cutting blades 58 of the punches 54 and the punches 54′. Note that the press working is a die less working and extracted scraps made when opening the through holes remain on the elastic mat 63 in a buried manner. Further, a stroke when forming the low opening region 48 is a length by which the large diameter cutting blades 60 do not make contact with the processed material 53.

Further, the punching folder 61 is once raised to pull out from the processed material 53 and thereafter displacing the position of the processed material 53 by a feed pitch F.P to lower the punching folder 61 again. Herewith, the through holes 47 whose shape is approximately the same as the outer shape of the standard cutting blade 58 (standard diameter: 15 μm) are formed by the standard cutting blades 58 of the punches 54 and punch 54′ as described above. By repeating the operation, holes having the standard diameter can be opened by the number of the punches 54, 54′ for every line of the pitch F.P. Then, when the punching holder 61 is lowered by a long stroke longer than the aforementioned stroke, the large diameter cutting blades 60 of the punches 54′ are punched into the outer edges of the through holes 47 of the processed material 53. Herewith, the large diameter cutting blades 60 pass through the material 53, and the through holes 49 whose shape is approximately the same as the outer shape of the large diameter cutting blade 60 (standard diameter: 20 μm) are formed. That is, the punch 54′ forms the through hole 47 whose inner circumference has approximately the same shape as the outer shape of the standard cutting blade 58, and the punch 54′ forms the through hole 49 whose inner circumference has approximately the same shape as the outer shape of the large diameter cutting blade 60. Accordingly, when the punching of the aforementioned long stroke is repeated at the feed pitch F.P, the through holes 47 are formed for the low opening region 48 by the standard cutting blades 58 of the punches 54 and the through holes 49 are formed for the high opening region 50 by the large diameter cutting blades 60 of the punches 54′. Note that, in FIGS. 8A, 8B, the holes are fabricated so as to be opened in a staggered manner by displacing the processed material 53 at the feed pitch F.P by two times while displacing the processed material 53 at ½ P.P in the width direction.

The through holes 47 having a standard diameter can be opened at the same time and the through holes 47 having a standard diameter and the through holes 49 whose diameter is larger than the diameter of the through holes 47 can be opened by using the same punch groups 55, 56 by aligning the first punch group 55 and the second punch group 56 on a same plane and by changing a punching distance (stroke) when punching into the processed material. Consequently a labor hour for exchanging the punch groups 55, 56 can be eliminated, and the low opening region 48 and the high opening region 50 can be easily formed in the processed material 53 to fabricate the filter 18.

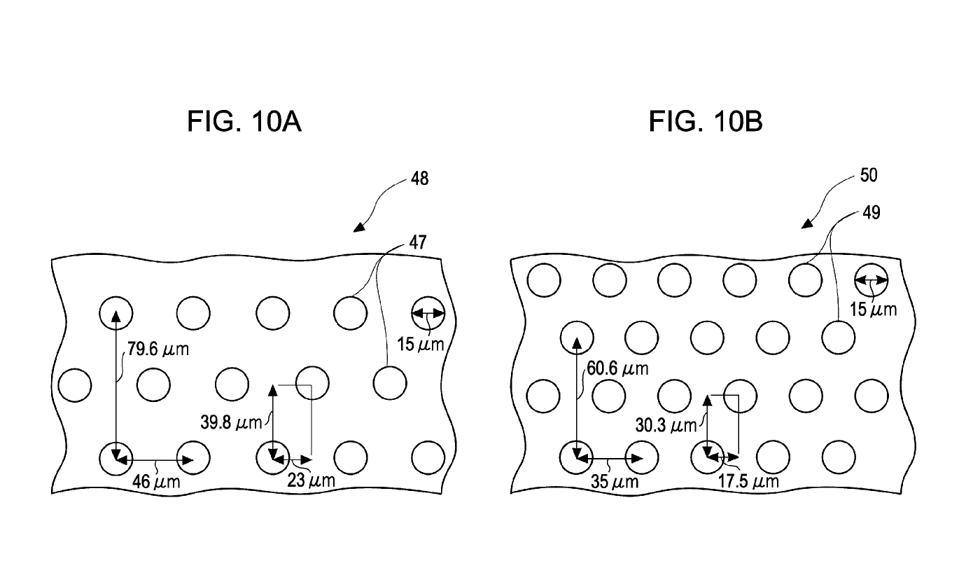

The diameter of the through holes 49 in the high opening region 50 is larger than the diameter of the through holes 47 in the low opening region 48 in the filter 18 of the aforementioned embodiment. However, as shown in FIGS. 10A, 10B, the filter 18 of the invention may be formed so that the diameter of the through holes 49 in the high opening region 50 and the diameter of the through holes 47 in the low opening region 48 may be the same and the number of the through holes 49 in the high opening region 50 per area may be larger than the number of the through holes 47 in the low opening region 48 per area.

Further, in the filter 18 of the aforementioned embodiment, two types of ranges, that is, the low opening region 48 in which the aperture ratio is low and the high opening region 50 in which the aperture ratio is high are formed. However, the filter 18 of the invention may be formed to have not less than three types of aperture ratios. That is, any constitution may be employed in the filter 18 of the invention as long as the aperture ratio of the holes is set to become higher as the holes approaches toward the center 52 from the outer edge 51 of the filter 18. Further, the high opening region 50 may be formed in a circle manner. Further, the positions of the low opening region 48 and the high opening region 50 formed on the filter 18 may be appropriately changed.

In the aforementioned structure, the aperture ratio of the through holes 47, 49 is set to become higher as the through holes 47, 49 approach toward the center 52 from the outer edge 51 of the filter 18. Accordingly, it is possible to reduce the pressure loss at the center 52 of the filter as much as possible. Accordingly, bubbles in fluid can be efficiently discharged.

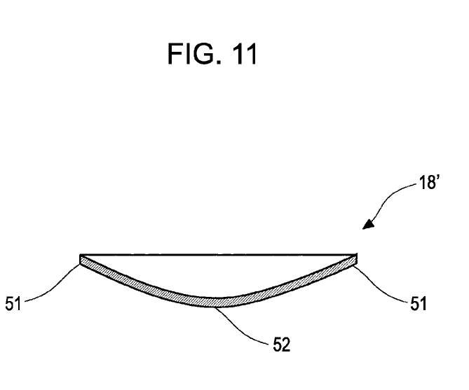

Further, the aforementioned filter 18 of the embodiment has a flat plate shape. However, as shown in FIG. 11, a filter 18′ of the invention may be bent towered the center 52 from the outer edge 51 so that the center 52 projects. In this case, the center 52 of the filter 18′ is disposed to project towered falling direction of fluid such as ink, bubbles, and the like.

The center 52 of the filter 18′ is positioned at the most downstream side, so that fluid such as ink, bubbles, and the like at the upstream side before passing the filter 18′ falls down along the surface of the filter 18′ at the upstream side and is to be inevitably assembled at a part (center) of the filter 18′. Consequently, the bubbles assembled at one portion can be efficiently discharged.

In the embodiment, the high opening region 50 is formed at the center 52 of the filter 18. However, in the invention, the high opening region 50 and the low opening region 48 can be formed at any portions as long as the high opening region 50 is formed at a portion at which flow amount of fluid (ink, bubbles, and the like) with respect to the filter 18 is large, a portion at which flow speed is high.

As described above, the printer 1 which is sort of the liquid ejecting apparatus is exemplified for description. However the invention can be applied to another liquid ejecting apparatus. For example, the invention can be also applied to a display manufacturing device for manufacturing a color filter for a liquid crystal display or the like, an electrode manufacturing apparatus for forming an electrode for an organic EL (Electro Luminescence) display, an FED (Field Emission Display), or the like, a chip manufacturing device for manufacturing a bio chip (biochemical element) and the like.

What is claimed is:

1. A filter having a plate-like shape in which a plurality of holes through which fluid passes is opened, wherein
a low opening region in which an aperture ratio of the holes per unit area is low and a high opening region in which an aperture ratio of the holes per unit area is high are formed in the filter.

2. The filter according to claim 1, wherein a diameter of the hole in the high opening region is larger than a diameter of the hole in the low opening region.

3. The filter according to claim 1, wherein
the number of the holes in the high opening region is larger than the number of holes in the low opening region.

4. The filter according to claim 1, wherein
an aperture ratio of the holes is set to become higher as the holes approaches toward a center from an outer edge of the filter.

5. The filter according to claim 1, wherein
the filter is bent toward a center from an outer edge so as to project toward a falling direction of fluid.

6. A liquid ejecting head for introducing fluid into a pressure chamber via a liquid flow path and for ejecting a liquid drop from a nozzle opening by pressure fluctuation, wherein
a filter according to claim 1 is equipped at a mid stream of the liquid flow path.

7. A liquid ejecting apparatus: comprising
the liquid ejecting head according to claim 6.

8. A press working method for working a filter by forming through holes by using punch groups in which plurality of punches are arranged with respect to a processed material, wherein
the punch groups includes,
a first punch group in which a standard cutting blade having a standard diameter is provided at a distal end of the punch,
a second punch group in which a standard cutting blade having the standard diameter is provided at a distal end of the punch and in which a large diameter cutting blade whose diameter is larger than the standard diameter is provided at a proximal side of the standard cutting blade, and wherein
working a filter in which a low opening region in which an aperture ratio of the holes per unit area is low and a high opening region in which an aperture ratio of the holes per unit area is high are formed by changing a punching distance when the punch groups are punched into the processed material.
